(19) United States
(12) Patent Application Publication
(10) Pub. No.: US 2015/0340139 A1
(43) Pub. Date: Nov. 26, 2015

(54) SUPERCONDUCTIVE COIL DEVICE AND PRODUCTION METHOD THEREFOR

(71) Applicant: SIEMENS AKTIENGESELLSCHAFT, Munich (DE)

(72) Inventor: Tabea ARNDT, Erlangen (DE)

(73) Assignee: Siemens Aktiengesellschaft, Munich (DE)

(21) Appl. No.: 14/433,286

(22) PCT Filed: Sep. 17, 2013
(86) PCT No.: PCT/EP2013/069221

§ 371 Date: Aug. 12, 2015

(30) Foreign Application Priority Data
Oct. 2, 2012 (DE) 10 2012 217 990.9

(51) Int. Cl. H01F 6/06; H01F 41/06; H01F 41/12; H01F 41/04

(52) U.S. Cl. CPC H01F 6/06; H01F 41/048; H01F 41/0687; H01F 41/12

(57) ABSTRACT

A superconductive coil device has a cylindrical carrier body at least two coil windings of a superconductive strip conductor that has a doubly connected topology and a continuous superconductive layer inside the doubly connected topology, and two conductor branches in two oppositely directed helical windings around the cylindrical carrier body. In a production method for such a superconductive coil device, the superconductive strip conductor with the doubly connected topology is produced by slitting a carrier strip along the length of the superconductive strip conductor, before or after applying the superconductive layer, and the slitted superconductive strip conductor is then wound on the cylinder carrier body in oppositely directed helical windings.

### BACKGROUND OF THE INVENTION

1. Field of the Invention

The present invention relates to a superconducting coil device having coil windings made of a superconducting tape conductor and to a production method for this coil device.

2. Description of the Prior Art

In order to generate strong homogeneous magnetic fields, superconducting coils which are operated in the persistent short-circuit current mode are used. Homogeneous magnetic fields with magnetic flux densities of between 0.5 T and 20 T are required, for example, for nuclear magnetic resonance spectroscopy (NMR spectroscopy) and for magnetic resonance imaging. These magnets are typically charged by means of an external circuit and then disconnected from the external current source, since an almost loss-free flow of current takes place through the superconducting coil in the resulting persistent short-circuit current mode. The resulting strong magnetic field is particularly stable as a function of time, since it is not influenced by the noise contributions of an external circuit.

When using known winding techniques, one or more superconducting wires is/are wound on support bodies, different wire sections being connected to one another by means of wire connections with the least possible ohmic resistance or by means of superconducting connections. For conventional low-temperature superconductors such as NbTi and Nb3Sn with critical temperatures below 23 K, there are technologies for producing superconducting contacts for joining wire sections and for connecting the windings to a superconducting persistent current switch. The superconducting persistent current switch is in this case part of the circuit of the coil and is put into an ohmically conducting state by heating in order to introduce an external current. After switching off the heating and cooling to operating temperature, this part of the coil also becomes superconducting again.

High-temperature superconductors, or high-T_{c} superconductors (HTS), are superconducting materials with a critical temperature above 25 K, and for some material classes, for example cuprate superconductors, above 77 K, in which the operating temperature can be reached by cooling with cryogenic materials other than liquid helium. HTS materials are particularly attractive for the production of magnetic coils for NMR spectroscopy and magnetic resonance imaging, since many materials have high upper critical magnetic fields of more than 20 T. Owing to the higher critical magnetic fields, HTS materials are in principle more suitable than low-temperature superconductors for generating high magnetic fields of more than, for example, 10 T.

One problem in the production of HTS magnetic coils is the lack of suitable technologies for producing superconducting HTS compounds, in particular for second-generation HTS, so-called 2G HTS. 2G HTS wires are typically in the form of flat tape conductors. When ohmic contacts are introduced between the superconducting tape conductors, the losses in the coil may become no longer negligible, and the magnetic field generated decreases significantly in a period of a few hours or days (cf. “IEEE Transactions on Applied Superconductivity”, Vol. 12, No. 1, March 2002, pages 476 to 479 and “IEEE Transactions on Applied Superconductivity”, Vol. 18, No. 2, June 2008, pages 953 to 956).

### SUMMARY OF THE INVENTION

An object of the present invention is to provide a superconducting coil device that avoids the aforementioned disadvantages. It is another object of the invention to provide a production method for such a coil device.

The coil device according to the invention has a cylindrical support body and at least two coil windings made of a superconducting tape conductor. The superconducting tape conductor has a doubly connected topology, and comprises a continuously superconducting layer inside the doubly connected topology. The superconducting tape conductor furthermore comprises two conductor branches which are arranged in two countersense helical windings around the cylindrical support body.

Consistent with the definition of “doubly connected” in geometrical topology, this term is used herein to mean that the superconducting tape conductor has the topology of a single loop with a hole. The “continuously superconducting layer inside the doubly connected topology” is intended to mean a layer which is superconductively connected over the entire loop, without there being a connection to an ohmic contact.

The coil device according to the invention makes it possible to generate a strong and homogeneous magnetic field that is constant as a function of time, since this coil device can be operated essentially loss-free in the persistent short-circuit current mode.

The method according to the invention provides a production method for a superconducting coil device having a cylindrical support body and a superconducting tape conductor that has at least a support tape and a superconducting layer. In this production method, a superconducting tape conductor with a doubly connected topology is produced by slitting the support tape in the direction of the length of the superconducting tape conductor before or after the superconducting layer is applied, and the superconducting tape conductor with a doubly connected topology is wound around the cylindrical support body in countersense helical windings.

The effect achieved by the production method according to the invention is that the continuously superconducting layer is formed inside the doubly connected topology, without requiring subsequent connection e.g. by a soldering process or sintering process.

In different embodiments of the invention, the coil device may additionally have the following features:

The superconducting layer may be a high-T_{c} superconductor.

The high-T_{c} superconductor may contain the material REBa₂Cu₃Oₓ, where RE stands for a rare earth element or a mixture of such elements.

The high-T_{c} superconductor may contain the material MgB₂.

At least one electrically insulating layer may be arranged between the coil windings.

The electrically insulating layer and the superconducting tape conductor may form a common winding tape to be prefabricated.

The superconducting tape conductor may lie essentially flat on the surface of the cylindrical support body.

The coil device may comprise a plurality of pairs of countersense helical windings lying above one another.

The superconducting tape conductor may comprise a heatable region which is in thermal contact with a heating apparatus. In this heatable region, the superconducting tape conductor acts as a superconducting switch which is put into an ohmically conducting state by heating. Such a switch advantageously makes it possible to introduce a current into the region of the coil device which remains superconducting.

The heatable region may lie outside the helical windings. Expediently, the heatable region is then not arranged so as to be in thermal contact with the cylindrical support body, so that heating of the region of the helical windings which remains superconducting is advantageously avoided.

Alternatively, the heatable region may form a part of the helical winding, which is thermally insulated from the cylindrical support body.

As an alternative to the heatable region, the coil device may comprise an apparatus for generating a local magnetic field, which can put a region of the superconducting tape conductor into an ohmically conducting state as a result of the local magnetic field.

The coil device may have at least two contacts for connecting the coil to an external current source.

Expediently, these two contacts are arranged on either side of the heatable region of the coil or on either side of the apparatus for generating a local magnetic field. An external current can then be introduced into the region of the coil which is still superconducting.

The production method may additionally have the following features:

The doubly connected superconducting tape conductor may be connected to an electrically insulating layer in order to form a prefabricated winding tape, and the winding tape may be unrolled from a stock roll in order to produce the countersense helical windings.

During the production of the countersense helical windings by unrolling from a stock roll, the stock roll may be threaded once through the superconducting tape conductor in order to produce each coil winding. This method is advantageously carried out with a 2G HTS tape conductor, which may be configured sufficiently torsionally stably for such a method.

The slitting of the simply connected superconducting tape conductor may be carried out with a laser or a diamond saw.

### BRIEF DESCRIPTION OF THE DRAWINGS

FIG. 1 is a schematic plan view of a superconducting tape conductor with a doubly connected topology in accordance with the invention.

FIG. 2 is an exemplary cross section of the superconducting 2G HTS tape conductor along the section plane II in FIG. 1.

FIG. 3 is a schematic side view of a superconducting coil device, which illustrates the winding of the conductor branches in the exemplary embodiment.

### DESCRIPTION OF THE PREFERRED EMBODIMENTS

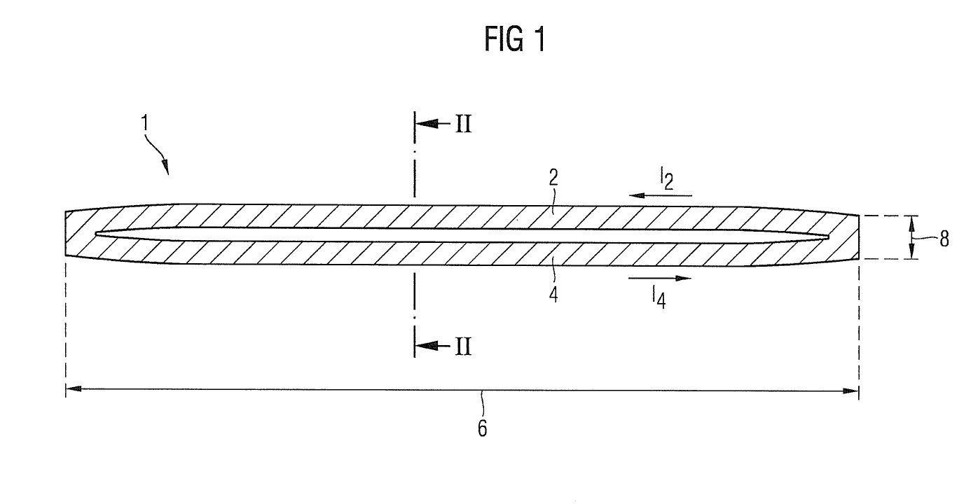

FIG. 1 is a schematic plan view of a superconducting tape conductor 1 with a doubly connected topology, which is produced by slitting a superconducting tape conductor with a simply connected topology. In this example, the slitting is carried out by means of a laser. The exemplary embodiment shown describes a coil device for NMR spectroscopy. In this example, the length 6 of the original simply connected tape conductor is 1000 m. This length may, however, be substantially shorter or longer. In a coil device for magnetic resonance imaging, the length may be a multiple of the length described here. The superconducting tape conductor comprises two approximately equally dimensioned conductor branches 2 and 4. A current I₂ flows through the first conductor branch 2, and a current I₄ flows through the second conductor branch 4 in the opposite direction, so that a closed ring current flows through the overall doubly connected superconducting tape conductor 1. The width 8 of the original simply connected tape conductor is in this example 10 mm, and the widths of the two conductor branches 2 and 4 in the region which is slit are respectively 5 mm. Depending on the tape conductor material used, this width of the conductor branches 2 and 4 may, however, also be substantially greater or less.

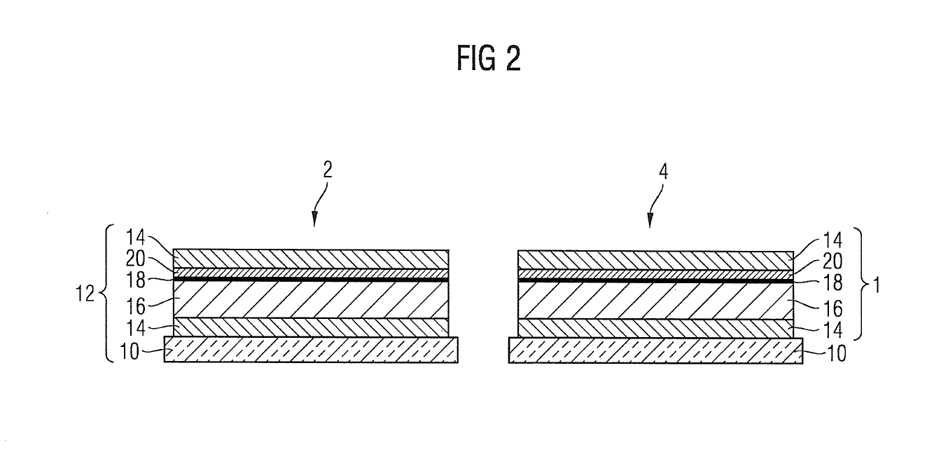

FIG. 2 shows a cross section through the superconducting tape conductor 1, in which the layer structure of a 2G HTS is represented schematically. In this example, the superconducting tape conductor 1 is connected firmly to an insulating layer 10 in order to form a winding tape 12. The insulating layer 10 is in this example a 50 μm thick Kapton tape, although it may also be made of other insulating materials, for example other plastics. The likewise doubly connected winding tape 12 comprises the two conductor branches 2 and 4 lying next to one another, the entire winding tape 12 with these conductor branches 2 and 4 lying next to one another being rolled onto a stock roll (not shown here) and the coil device being produced by unrolling the doubly connected winding tape 12 from the stock roll. The layer structure of each conductor branch 2, 4 comprises, over the insulating layer 10, first a normally conducting cover layer 14, which in this example is a 20 μm thick copper layer. This is followed by the support tape 16, here a 50 μm thick substrate made of a nickel-tungsten alloy. As an alternative, steel tapes or tapes made of an alloy, for example Hastelloy, may also be used. Arranged over the support tape 16, there is a 0.5 μm thick buffer layer 18 which contains the oxide materials CeO₂ and Y₂O₃. Following over this, there is the actual superconducting layer 20, here a 1 μm thick layer of YBa₂Cu₃Oₓ, which is in turn covered with a 20 μm thick cover layer 14 of copper. The superconducting layer 20 forms a continuous layer over the entire doubly connected topology. As an alternative to the material YBa₂Cu₃Oₓ, it is also possible to use the corresponding compounds REBa₂Cu₃Oₓ of other rare earths. In the example shown, in each conductor branch 2, 4 the width of the insulating layer 10 is somewhat greater than the width of the rest of the superconducting tape conductor 1, so that conductor branches which come to lie on top of one another when the coil device is being wound are reliably insulated from one another. As an alternative to the example shown, insulating layers 10 may also be arranged on both sides of the superconducting tape conductor 1, or the lateral regions of the superconducting tape conductor 1 may be protected by insulating layers. It is furthermore possible to braid an insulating layer as a separate tape into the coil device during the actual production of the coil winding.

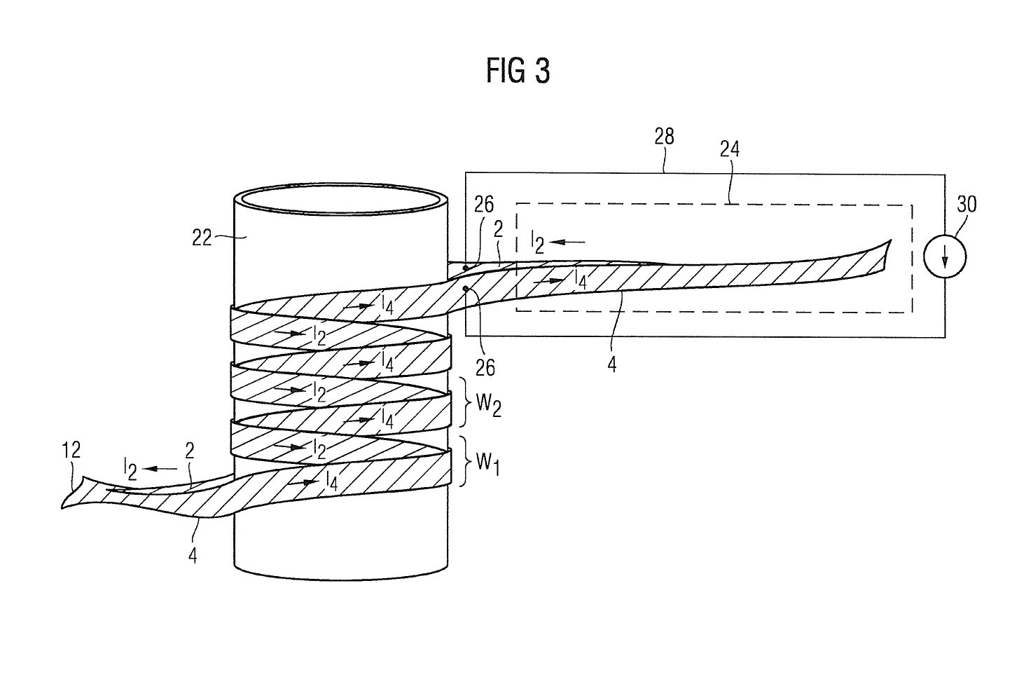

FIG. 3 shows a schematic side view of the superconducting coil device, which illustrates the winding of the conductor branches 2 and 4 in the exemplary embodiment. The two conductor branches 2 and 4 are arranged in mutually countersense helical windings around the cylindrical support body 22. From the current arrows I₂ and I₄ shown in FIG. 3, it can be seen that the ring current flowing through the tape conductor in the two conductor branches 2 and 4 flows in the same sense around the cylindrical support body 22, so that a strong magnetic field can be generated by the coil device. The cylindrical support body 22 is a hollow cylinder in this example, the sample volume for the samples to be spectroscopically examined being arranged in the interior of the hollow cylinder. Expediently, during operation of the superconducting coil device, the entire superconducting tape conductor 1 is cooled to a temperature below the critical temperature, the cylindrical support body 22 also being cooled to a very low temperature. The cylindrical support body 22 is insulated from the sample volume, however, so that the samples to be measured do not need to be cooled.

FIG. 3 shows only a few windings W₁, W₂, . . . by way of example, the actual coil device typically comprising a multiplicity of such windings, and in this example there are 5000 windings. These windings may also be configured in a multiplicity of layers of countersense helical windings lying above one another. Within each full winding W₁, W₂, . . . , the two conductor branches 2 and 4 cross over two times, the conductor branch 2 and the conductor branch 4 always respectively lying alternately on top in this example. With this arrangement, it is possible to unroll the doubly connected winding tape 12 in one piece from a stock roll (not shown here), without the doubly connected topology having to be interrupted for the production process, and without a connection of the superconducting layer subsequently having to be provided. As can be seen in FIG. 3, the superconducting tape conductor lies essentially flat on the cylindrical support body in the region of the windings W₁, W₂, . . . .

FIG. 3 furthermore shows two contacts 26, by which the superconducting tape conductor 1 is connected to an external circuit 28. This circuit 28 is used to introduce a current into the coil device by means of a current source 30 during first use or when charging the coil. The contacts 26 are here configured as plug-in contacts, so that the connection to the circuit 28 can be disconnected after the charging process. In spatial proximity to the contacts 26, there is a heatable region 24 in which the superconducting tape conductor is in thermal contact with a heating apparatus (not shown here), so that in order to charge the coil this region can be heated to a temperature above the critical temperature and therefore becomes ohmically conducting. This arrangement leads to the formation of a superconducting switch in this region, which makes it possible to introduce the charging current into the region of the coil which is still superconducting. After introduction has been carried out, the heating apparatus can be turned off, so that the entire region of the superconducting tape conductor 1 becomes superconducting again and the coil becomes an approximately loss-free conductor in the persistent short-circuit current mode. In the example shown, the heatable region 24 is arranged separately from the cylindrical support body 22 and does not contain any coil windings. This allows good thermal insulation of the heatable region 24 from the cooled cylindrical support body 22. As an alternative, however, the heatable region 24 may also be wound in helical windings, so that this region likewise contributes to the generation of the magnetic field in the persistent short-circuit current mode. In this case, it is expedient for the windings of the heatable region to be arranged around a separate support body, which is thermally insulated from the cylindrical support body 22.

Although modifications and changes may be suggested by those skilled in the art, it is the intention of the inventor to embody within the patent warranted heron all changes and modifications as reasonably and properly come within the scope of his contribution to the art.

1. A superconducting coil device comprising:
a cylindrical support body and at least two coil windings made of a superconducting tape conductor, said superconducting tape conductor having a doubly connected topology and comprises a continuously superconducting layer inside the doubly connected topology and two conductor branches arranged in two countersense helical windings around the cylindrical support body.

2. The coil device as claimed in claim 1, wherein the superconducting layer (20) comprises a high-Tc superconductor.

3. The coil device as claimed in claim 2, wherein the high-Tc superconductor contains REBa₂Cu₃Oₓ or MgB₂.

4. The coil device as claimed in claim 1, comprising at least one electrically insulating layer arranged between the coil windings.

5. The coil device as claimed in claim 4, wherein said at least one electrically insulating layer and the superconducting tape conductor form a common winding tape.

6. The coil device as claimed in claim 1, wherein the superconducting tape conductor lies essentially flat on the surface of the cylindrical support body.

7. The coil device as claimed in claim 1, comprising a plurality of pairs of countersense helical windings lying above one another.

8. The coil device as claimed in claim 1, wherein the superconducting tape conductor comprises a heatable region which is in thermal contact with a heating apparatus.

9. The coil device as claimed in claim 8, wherein the heatable region (24) lies outside the helical windings.

10. The coil device as claimed in claim 8, wherein the heatable region forms a part of the helical windings, which is thermally insulated from the cylindrical support body.

11. The coil device as claimed in claim 1, comprising an apparatus for generating a local magnetic field that places a region of the superconducting tape conductor in an ohmically conducting state as a result of the local magnetic field.

12. The coil device as claimed in claim 1, comprising at least two contacts for connecting the coil to an external current source.

13. The coil device as claimed in claim 12, wherein the superconducting tape conductor comprises a heatable region in thermal contact with a heating apparatus, and wherein the contacts are arranged on either side of the heatable region.

14. A method for producing a superconducting coil device having a cylindrical support body and a superconducting tape conductor, which comprises at least a support tape and a superconducting layer, said method comprising producing a superconducting tape conductor with a doubly connected topology by slitting the support tape in the direction of the length of the superconducting tape conductor before or after the superconducting layer is applied, and winding the superconducting tape conductor with the doubly connected topology around the cylindrical support body in countersense helical windings.

15. The method as claimed in claim 14, comprising connecting the doubly connected superconducting tape conductor to an electrically insulating layer in order to form a prefabricated winding tape, and unrolling the winding tape from a stock roll in order to produce the countersense helical windings.

16. The coil device as claimed in claim 12 comprising an apparatus for generating a local magnetic field that places a region of the superconducting tape conductor in an ohmically conducting state as a result of the local magnetic field, and wherein the contacts are arranged on either side of the apparatus for generating said local magnetic field.
